(19) United States
(12) Patent Application Publication
(10) Pub. No.: US 2010/0071203 A1
(43) Pub. Date: Mar. 25, 2010

(54) CRIMPING MACHINE FOR DIFFERENT CRIMPING AND PRESSING PROCESSES, IN PARTICULAR FOR CABLE ASSEMBLY

(75) Inventor: Willi Blickenstorfer, Stallikon (CH)

Correspondence Address: DAVIS & BUJOLD, P.L.L.C., 112 PLEASANT STREET, CONCORD, NH, 03301, US

(73) Assignee: SCHLEUNIGER HOLDING AG, Thun (CH)

(21) Appl. No.: 11/993,534

(22) PCT Filed: Jun. 22, 2006
(86) PCT No.: PCT/IB06/01695

§ 371 Date: Dec. 21, 2007

Related U.S. Application Data
(60) Provisional application No. 60/595,443, filed on Jul. 5, 2005.

(30) Foreign Application Priority Data
Jun. 23, 2005 (CH) 01073/05
Jul. 4, 2005 (CH) 01123/05
Oct. 6, 2005 (CH) 01623/05
Apr. 7, 2006 (IB) PCT/IB06/051070

(51) Int. Cl. H01R 43/048

(52) U.S. Cl. 29/753

(57) ABSTRACT

A crimping machine for crimping and pressing processes, in particular for semiautomatic or fully automatic mounting of a contact element to a cable end during cable assembly. It has a crimping station including a crimping tool, a tool holder, a drive unit, a contact feed and a contact store. The crimping tool and the contact store are an assembly which can be separated from the drive unit. The crimping tool is formed as two parts, and the tool holder has a clamping device for one part of the crimping tool and an adjusting head fixing unit for orienting and fixing another part of the crimping tool. The assembly is an integrated tool unit which includes at least the crimping tool, the contact strip un-winder preferably with a contact strip spool, the contact strip guide and a drivable paper strip winder. The crimping machine preferably includes an automatic tool identification system.

### FIELD OF THE INVENTION

The invention relates to a crimping machine for different crimping and pressing processes, for example for cable assembly, a crimping tool, by its relative movement, crimping, i.e. pressing, a crimp contact with an electrical conductor end for the production of a crimp connection.

### PRIOR ART

DE-10301550 discloses such a crimping tool of the same Applicant which can be used for various crimping machines and fully automatic crimping machines.

As known in practice, automated crimping devices, so-called automatic crimping machines, are used for processing electric cables for, for example, automotive cable sets. These automatic machines perform the following functions:
drawing in and cutting to length of the cable with a transport system,
holding and positioning of the cable ends with pivotable grippers,
parting of the cable,
stripping of the insulation from the two cable ends,
swiveling the cable ends to processing stations:
   a) optional automatic pushing of seals onto the cable end (in sealing stations) and
   b) pressing (crimping) of electrical contacts on the cable end (in crimping stations),
placing the finished cables in a collecting trough and
placing the programmed quantity of cable bundles in a removing trough.

Different cable types, cable colors and cable cross-sections and different crimp contacts and, if required, also seals are used in these cable sets. Since the production sizes of such cable sets are very small in some cases the automatic machine must be converted as soon as another cable type, another cable color, another cable cross-section or another cable crimp contact has to be processed. The conversion times influence the cost-efficiency of an automatic crimping machine.

In the conversion of conventional fully automatic crimping machines, the following components are interchangeable parts on the crimping station: the crimping tool and the crimp contact spool. The following manual work has to be performed for this purpose:
stop fully automatic machine,
automatically open the safety hood,
open brake for contact strip at crimping tool,
withdraw contact strip manually from the crimping tool,
fix contact strip to a contact spool so that the strip does not fall from the spool,
tear off paper strip on the contact spool,
remove spool with wound paper strip from a paper strip winder,
open paper strip spool and remove wound paper,
close paper strip spool and push onto winding device,
remove clamping disc from spool holder axle,
remove contact spool and place in storage location,
remove new contact spool from storage location and push onto the spool holder axle,
push on clamping disc and tighten with slight spring tension,
release clamping device for the crimping tool at the crimping station,
remove crimping tool from the crimping station and deposit at storage location,
remove new preadjusted crimping tool from the storage location and insert into the crimping station,
close clamping device so that the crimping tool is fixed,
release contact strip from the contact spool, align end or cut to aligned length using a side cutter,
release brake on crimping tool and thread the contact strip into the crimping tool guide until the first contact is present on the bottom punch,
close brake on crimping tool,
thread paper strip into the paper strip spool and clamp firmly,
close safety hood,
load saved data on the PC of the crimping machine and activate,
automatically prepare cable with a test crimp,
remove the cable with test crimp from a storage trough, measure crimp width and height, assess cable insertion depth,
adapt crimping tool adjustment depending on test result.

As is evident from the above, the conversion of the conventional automatic crimping machines for different crimping operations requires a great deal of time and manual work, which, however, limit the productivity of the device.

EP-1043814 describes a crimping device in which a processing unit for crimping a contact element onto a stripped cable end and a storage unit for contact elements is in the form of an assembly which can be separated from a drive unit of the crimping device. However, the specific detailed technical solution is not disclosed there. It is therefore unclear how and whether paper strip winders are provided, whether and how the adjusting head can be fixed, how the crimping tool is fixed on the crimping machine, etc.

In this known publication, it is also unclear whether and how the tool can be locked. On removal of this assembly from the press, it probably collapses because in fact the tool moves downward under its own weight. However, the feed (not unambiguously disclosed) for the contact strip is possibly coupled therewith. Consequently, undefined feeding of the contact material would occur, which can lead to an undefined state on reinsertion of the assembly into the press. Although the stoppages necessary for tool and/or contact change can be reduced thereby, the orientation and fixing of the assembly in the gap between the drive unit and a baseplate is also problematic which can adversely affect the operating quality of the device.

### SUMMARY OF THE INVENTION

The aim of the invention is to eliminate the stated disadvantages of the known device, i.e. to further reduce the time and manual work requirement of the conversion for the crimping tool, the crimp contact spool and the paper strip winder.

It is intended thereby to provide an improved arrangement for the crimping machine, which can be converted relatively rapidly and easily according to the different cable types, cable colors and cable cross-sections and different crimp contacts, in each case a prescribed precise orientation and fixing of the interchangeable parts being ensured, and thus to make it possible to increase the productivity and accordingly the quality of crimping, in particular in cable assembly.

The object set is achieved in a first step by the present invention according to claim 1. The subclaims refer to advantageous developments.

The essence of the invention is now to be seen in the fact that the tool holder for the two-part tool has a special clamping device and a preferably pneumatically actuatable adjusting head fixing means for orientation and fixing of the adapted crimping tool; and that the contact feed has a contact strip unwinder and at least one contact strip guide. Moreover, the assembly is in the form of an integrated tool unit which comprises at least the crimping tool, the contact strip unwinder, preferably with a contact strip spool, the contact strip guide and a paper strip winder, is removable from the crimping station and is equipped with a baseplate cooperating with the clamping device of the crimping station and exactly orienting the integrated tool unit in its installed state.

In a preferred embodiment of the invention, a blocking mechanism is provided which is formed to prevent an advance of the movable tool part in the integrated tool unit—before it is removed from the crimping machine together with the integrated tool unit and/or an interlocking lever is provided which, on insertion of the crimping tool into the crimping machine or into the integrated tool unit, automatically cancels the blocking state as soon as the removable part is held in the adjusting head fixing means.

For the user, the various inventive measures therefore result in the following:
1. Rapid and easy (manual or automatic, depending on basic machine) changing of the tools (contacts) in an automatic crimping machine. Changing time e.g. less than 30 sec.
2. All necessary setup work can be carried out outside the automatic machine (insert new contact spool, thread in paper strip and pretension, position contacts (strip) exactly in the tool, correctly snap in contact feed finger, adjust brake of the contact spool, adjust alignment of the contact spool with the tool, if required change wearing parts on the tool, overwrite memory chip or read in new data, etc.). A rocker switch according to the invention switches the paper strip winding motor on and off and thus permits an adjustable spring pretension for different contacts.
3. All settings mentioned under point 2 can, according to a particular development, be retained on cassette change. Positively controlled, mechanical unlocking or locking of the movable, upper tool part leads to securing of the contact position in the tool and to automatic coupling of the tool in the crimping press (T-slot).
4. The new system permits the use (integration) of standard tools (e.g. AMP (R) compatible).
5. A preferred development permits a particularly economical solution for the tool unit, i.e. all active elements, such as winding motor for the paper strip, sensor for the rocker switch, sensor for the crimping force control, reader for the memory chip, etc., are coordinated with the automatic machine so that there is no coupling of electrical or pneumatic connections between tool unit and crimping machine. On the other hand, according to a particular development, the winding device is inactive and is equipped with a static braking effect for the paper strip. (The paper strip is thus prevented from “unrolling” when the cassette is removed.) A particular contact spool holder with adjustable braking effect prevents a defined (contact-dependent) brake setting from being lost when a spool is changed. In a further development, a possibility for axial adjustment is also provided. The defined position (contact-dependent alignment with the tool) is then not lost when a spool is changed.
6. Handles permit a very light and ergonomic design of the tool unit (manual handling).
7. A particularly preferred design envisages that all setup and exchange work can be carried out without tools.

The product duality and in particular the conversion speed can be further increased if a tool identification system which is provided with a data store and a data transmission device for transmitting data from the data store and for receiving data for the data store is used in the crimping machine. According to the invention, it is in the form of an automatic tool identification system (ATIS) which in practice has two units separated from one another but with wireless communication between one another, i.e. an ID unit, and a read unit. The ID unit is the portable tool unit but the read unit is coordinated with the crimping machine. The ID unit consists of a reprogrammable tool data store and a first transmission part. (Non-programmable data media can also be used, e.g. transponders which contain a unique, readable identifier. On the basis of this read identifier, the base machine activates data from an internal database or the like.) The read unit consists of a processor/memory and a second transmission part, and the read unit has a control link to the crimping machine.

This tool identification system can advantageously be used for any desired crimping machines, even independently of the integration according to claim 1. This means that the individual components which can be connected to a crimping machine can be equipped with “ATIS”, i.e. for example the spool and/or the crimping tool. In combination with the integration according to claim 1, however, the object set at the outset is particularly advantageous manner.

The invention can also be used on table crimping devices (semiautomatic machines). The most important advantages of the invention and further details are to be found below in the detailed description of the figures.

### BRIEF DESCRIPTION OF THE DRAWINGS

The invention is explained in more detail with reference to the attached drawings.

FIG. 1 shows a perspective view of a working example of the crimping machine according to the invention,

FIG. 2 shows a part of the crimping machine according to FIG. 1, on a larger scale,

FIG. 3 shows an integrated tool unit, according to the invention, of the crimping machine according to FIG. 1,

FIG. 4 shows a clamping device for the integrated tool unit,

FIG. 5 shows the schematic diagram of a drive for a paper strip winder,

FIG. 6 shows a view of the adjusting head fixing means, partly dismantled,

FIG. 7 shows a storage rack for a plurality of integrated tool units,

FIG. 8 shows a block diagram of a working example of the automatic tool identification system according to the invention for a crimping machine,

FIGS. 9-14 show another working example of the crimping machine according to the invention, which is in the form of a table-top device,

FIG. 9 showing a perspective view of a crimping machine,

FIG. 10 showing a side view of a part of the table-top device according to FIG. 9, before insertion of the integrated tool unit (TSS)

FIG. 11 showing a perspective picture of the table-top device part according to FIG. 10, with the integrated tool unit (TSS) in the inserted state, and on a larger scale,

FIG. 12 showing a side view of the solution according to FIG. 11,

FIG. 13 showing a side view of the crimping machine according to FIG. 9,

FIG. 14 showing a perspective view of the solution according to FIG. 10;

FIGS. 15-17 show a further arrangement of the crimping machine according to the invention, FIG. 16 showing a side view in the direction of the arrow XVI, and FIG. 17 showing a section along the line XVII-XVII in FIG. 5; and

FIG. 18 shows a preferred arrangement of the crimping machine according to the invention which is formed as a modular cable processing centre by a twin arrangement of two crimping presses according to the invention.

### DESCRIPTION OF THE WORKING EXAMPLES

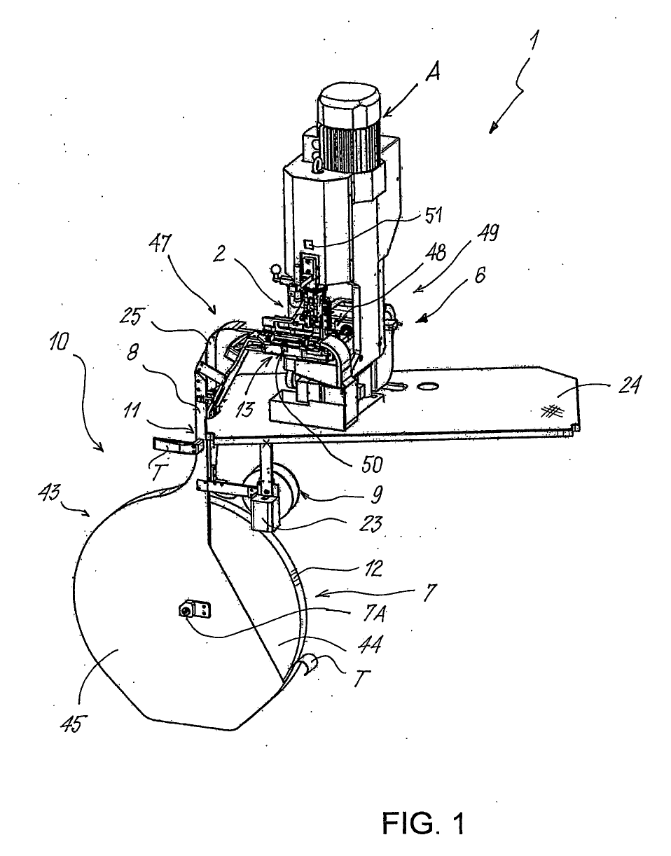

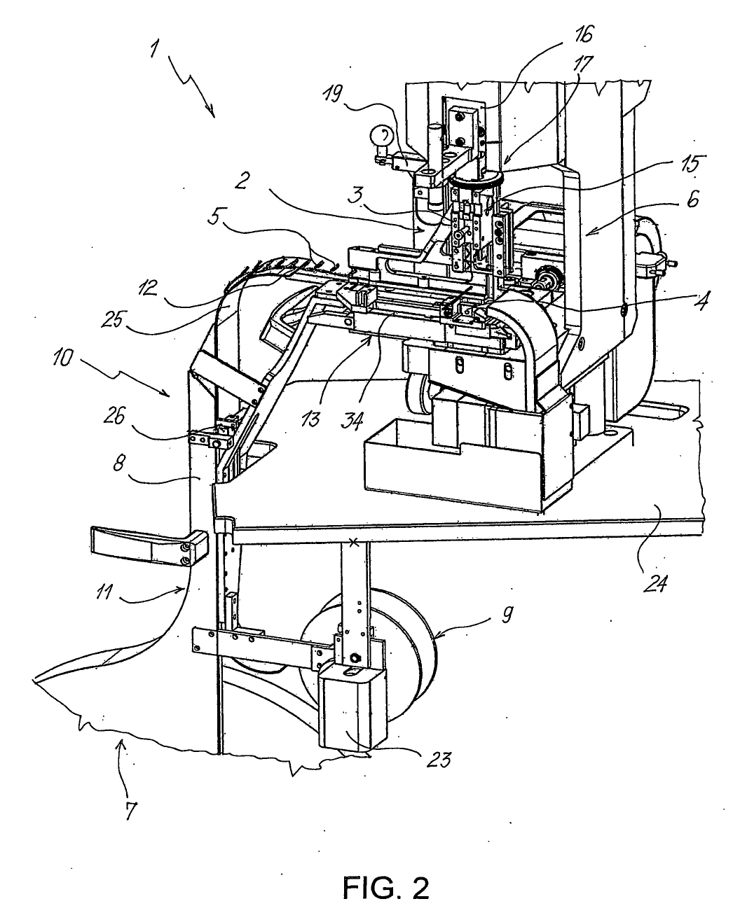

FIGS. 1 and 2 show a working example of the crimping machine 1 according to the invention, which is provided with a transverse contact feed 47 (the known feed of the electric cables with stripped ends is not shown). This crimping machine 1 can be used for different crimping and pressing processes, for example cable assembly, and is provided with a two-part crimping tool 2 and a tool holder 48, a movable upper tool 3 of the crimping tool 2, by its relative movement, “crimping”, i.e. pressing, a crimp contact 5, which can be placed on a fixed lower tool 4 of the crimping tool 2, with an electrical conductor end for producing crimped joints.

The crimping machine 1 has a crimping station 6 which is provided with the crimping tool 2, the tool holder 48, a drive unit A and the contact feed 47 (the crimping tool 2 with its drive unit A and tool holder form the so-called “crimping press”). Such a crimping tool 2 is, for example, commercially available under the name “UNI-A” or “UNI-C” tool or is disclosed in DE-A-10301560 of the same Applicant. The crimping tool 2 is exchangeably inserted and fixed in the crimping station 6.

In the embodiment shown, the crimp contacts 5 are so-called transverse-transport crimp contacts, which are introduced laterally into the crimping station 6 (FIG. 2). It should, however, be noted that there are also so-called longitudinal-transport crimp contacts, which can be introduced from behind into the crimping station. The conversion of the invention is also conceivable for both versions.

According to the invention, the following components of the crimping machine 1, namely the crimping tool 2, a contact strip unwinder 7 and at least one contact strip guide 8, and a paper strip winder 9, are integrated to give a common portable tool unit 10 (tooling shuttle, abbreviated to: “TS”), which is provided with a portable basic rack 11.

The embodiment of the integrated portable tool unit 10 shown (cf. FIGS. 1 and 2) therefore comprises the adjusted crimping tool 2, the contact strip guide 8, the contact strip unwinder 7 (optionally with a contact strip 12 or a contact strip spool 44) and the paper strip winder 9. The integrated tool unit 10 is thus formed so as to be portable (FIG. 1) and has for this purpose two carrying handles T. In the arrangement according to the invention, the integrated portable tool unit 10 can be pushed completely into a lower clamping device 13 of the tool holder 48 at the crimping station 6 and can be fixed there—in its oriented and adjusted position—by actuating a lever 14.

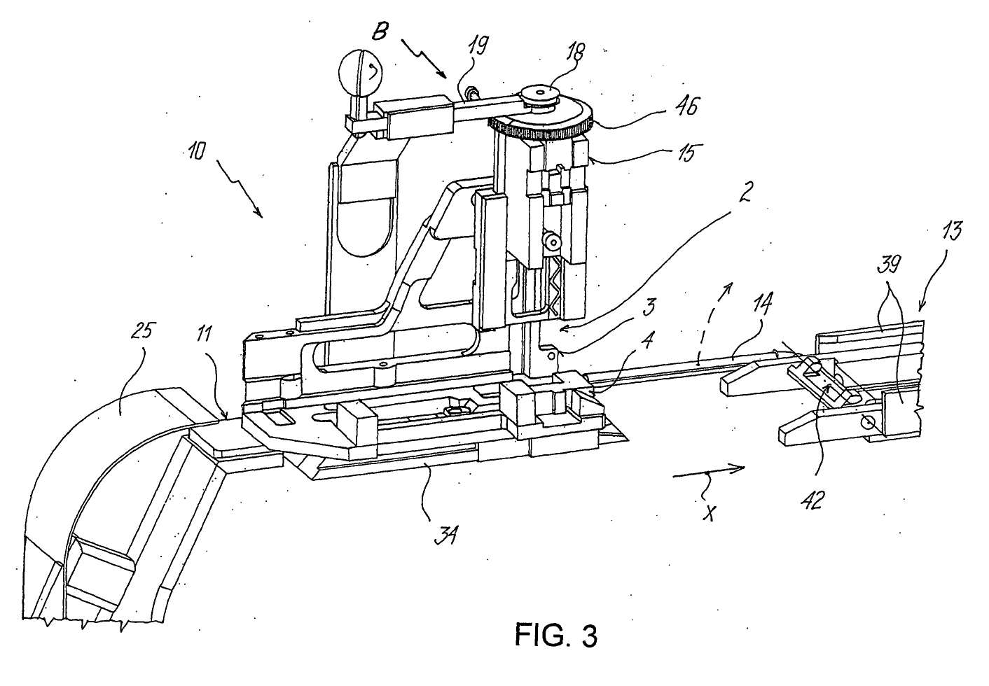

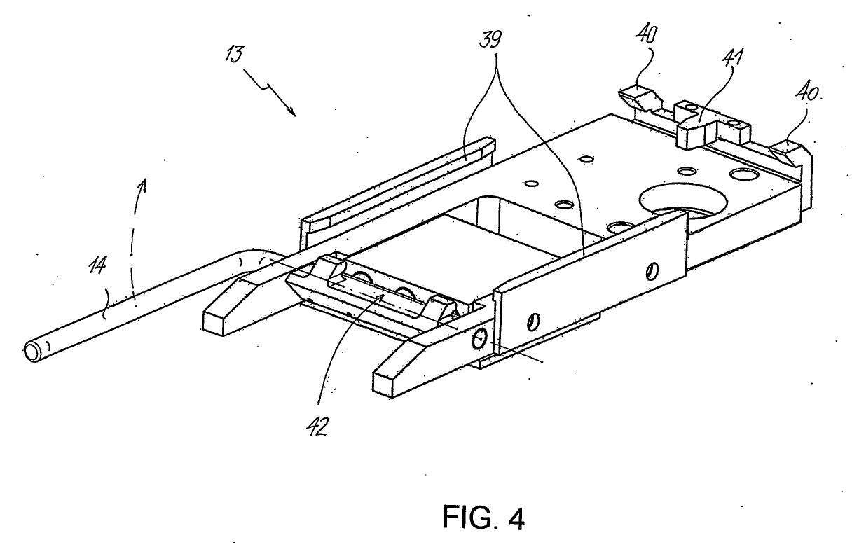

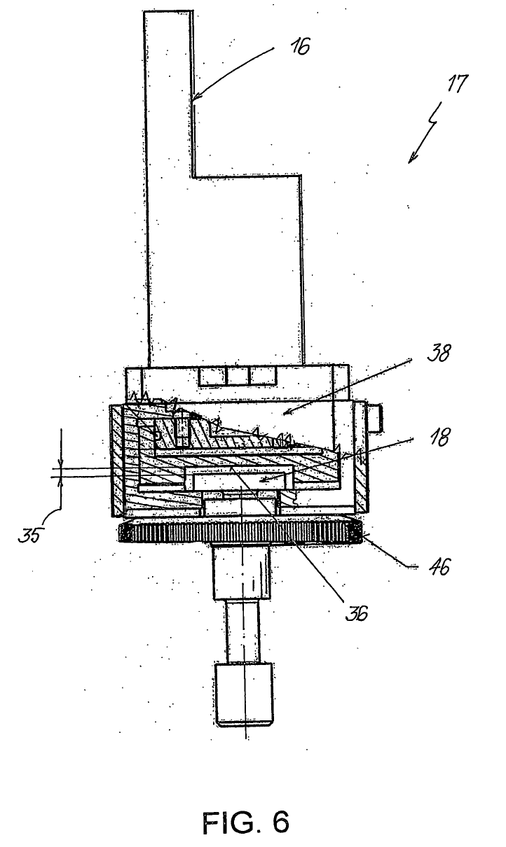

In FIG. 3, a crimping tool head is designated by 15. A holding slide 16 on the crimping station 6 (FIG. 2) adapts the crimping tool head 15 by triggering a pneumatically actuatable adjusting head fixing means 17. An adjusting head tailored in height is designated by 18 (FIG. 6) and a slide for holding the crimping tool head 15 is designated by 19 (FIGS. 2 and 3).

The invention provides a blocking mechanism B (FIG. 3) which prevents an advance of the movable tool part/upper tool 3 (e.g. due to gravity or due to the weight of the part 3 itself) of the two-part crimping tool 2 in the integrated tool unit 10 during changing of the integrated tool unit 10. In its blocking state, the blocking mechanism B preferably cooperates with the adjusting head 18 by means of the optionally hand-actuatable slide 19.

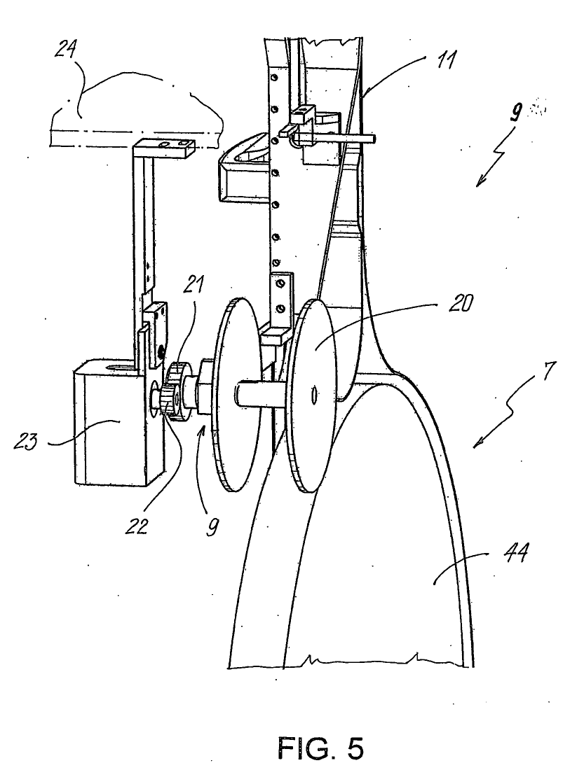

It is clear from FIG. 5 that the paper strip winder 9 of the integrated tool unit 10 has a spool 20 for paper strips and a gear wheel 21 which can be rotated together with the spool 20 and, on installation of the tool unit 10, couples automatically by means of a driving gear wheel 22 of a drive motor 23. The drive motor 23 is fixed to a machine table 24 of the crimping machine 1 (i.e. to the basic machine) (cf. FIGS. 1 and 5). A rocker switch 25 for controlling the drive motor 23 is arranged here on the integrated tool unit 10 in such a way that, when the tool unit 10 is installed, a sensor 26 for motor actuation on the basic machine is actuated (FIG. 2). As an alternative to gear wheels, it is also possible to use friction wheels or the like.

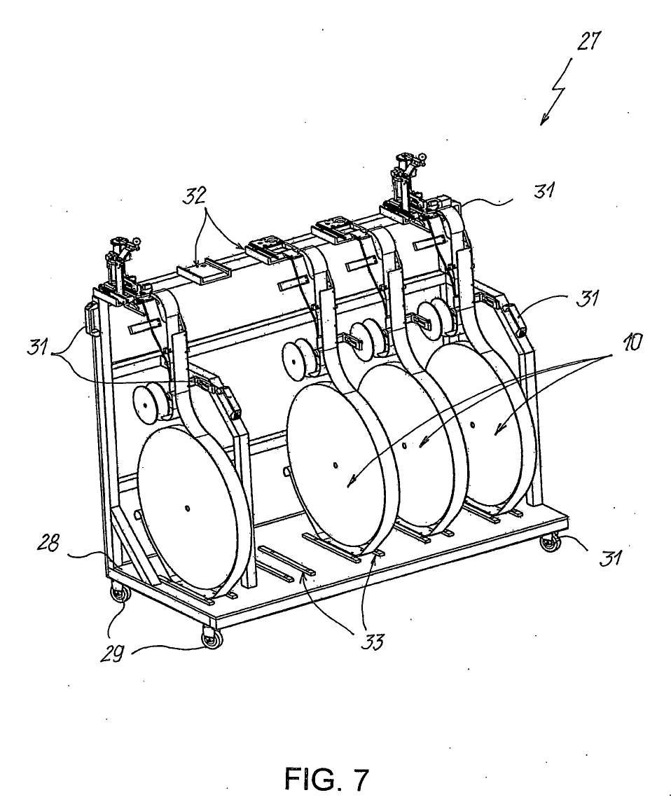

FIG. 7 illustrates a separate storage rack 27 which serves for storing integrated tool units 10. The storage rack 27 therefore permits secure storage of a plurality of completely adjusted tool units 10. Here, the storage rack 27 has a chassis 28 with wheels 29 which permit travel of the storage rack 27. In the embodiment shown, two wheels 29 are each equipped with a lockable holding brake 30 to prevent independent rolling away. Two handles 31 on each side ensure safe handling of the storage rack 27 during transport. For holding the integrated tool units 10, the storage rack is provided with upper and lower holding rails 32 and 33. With the aid of the storage rack 27, the prepared tool units 10 can preferably be centrally stored and, if required, can be moved to one or more crimping machine(s) 1.

In the arrangement according to the invention, the lower clamping device 13 for holding and orientation of the integrated tool unit 10, and the upper pneumatic adjusting head fixing means 17 for holding and orientation of the crimping tool head 15, are therefore arranged on the crimping station 6 (FIG. 2).

As is evident from the above, the arrangement according to the invention contains in practice the following individual modules:
the special adjusting head fixing means 17 on the holding slide 16, which is present on the crimping station 6,
the tool holder 48 with the special lower clamping device 13 for holding the integrated tool unit 10, which is likewise present on the crimping station 6;
the contact strip unwinder 7 (optionally with the contact strip spool 44), which is arranged on the basic rack 11 of the integrated tool unit 10;
the drive motor 23, which is fixed (complete with the gear wheel 22 and the sensor 26); the machine table 24;
the paper strip winder 9 for winding the paper strip (without contacts after the crimping phase), which is arranged on the basic rack 11 of the integrated tool unit 10;
the separate storage rack 27 for storing a plurality of integrated tool units 10.

The adjusting head fixing means 17 has the function of reducing to an adjustable minimum a play 35 (cf. FIG. 6) between the adjusting head 18—at the receiving peg of the crimping tool 2—and a T-slot 36 in an adjusting head holder 37—at the tool holding slide 16 on the crimping station 6. The adjusting head fixing means 17 is equipped here with a pneumatic cylinder 38 (FIG. 6).

After the insertion of the integrated tool unit 10 into the lower clamping device 13 and upper adjusting head fixing means 17 of the crimping station 6, the operator actuates a push button (not shown), and the adjusting head 18 is pneumatically clamped with the aid of the pneumatic cylinder 38. This function can also be automatically triggered by means of software of the crimping machine 1 since the integrated tool unit 10 is recognized in predetermined position and attitude, for example by sensors.

The lower clamping device 13 permits exact orientation and rapid clamping of the baseplate 34 of the integrated tool unit 10 in the crimping station 6. After the baseplate 34 of the integrated tool unit 10 was inserted into lateral guide bars 39 of the clamping device 13 against one or more stop(s) 40 (cf. FIG. 3) and was centered in between by a centering element 41, the baseplate 34 of the integrated tool unit 10 is fixed in an interlocking manner with the clamping device 13. For this purpose, the lever 14 is moved through about 90°, and a spring-actuated toggle lever clamping system 41 is actuated thereby.

The clamping device 13 having lateral guide bars 39 and/or the centering element 41 and/or the stop 40 orients the baseplate 34 of the integrated tool unit 10 on the crimping station 6 (cf. FIG. 3), and for this purpose the baseplate 34 has elements cooperating in a diametrically opposite manner (e.g. control edge, bevels, etc).

The integrated tool unit 10 is thereby exactly centered, oriented, fixed and clamped, and is secured to prevent it from tilting backward after insertion into the guide bars 39. If appropriate, the exact position of the integrated tool unit 10 can be polled by means of a sensor and reported to a central machine computer (not shown).

The contact strip unwinder 7 shown (FIGS. 1 and 2) consists here of a contact spool holder 7A, a contact spool receptacle 43, the contact strip guide 8 and the rocker switch 25. A contact strip spool 44 is arranged on the contact spool holder 7A in the contact spool receptacle 43 (FIG. 1). The contact strip spool 44 is surrounded by a covering 45 for adequately protecting the crimp contacts 5 of the contact spool 44 from damage. This covering 45 can optionally be omitted for weight and cost reasons.

The paper strip winder 9 is—as mentioned above—therefore arranged on the integrated tool unit 10 but is driven by means of the gear wheel pair 21, 22 by the drive motor 23 only when the tool unit 10 is in the installed state (in the crimping station 6).

Returning to FIGS. 2 and 3, the slide 19 has the function of keeping the adjusting head 18 on the crimping tool head 15 at the prescribed height so that insertion into the adjusting head holder 37 (FIG. 6) is possible. An adjusting wheel of the adjusting head 18 is designated in FIG. 6 by 46. The operating and rest positions of the slide 19 can be polled, for example, by means of a sensor (not shown). The crimping machine 1 can be triggered only when slide 19 is withdrawn from the crimping tool head 15 and locked in the rest position. In this embodiment, the slide 19 is locked in both end positions.

The drive motor 23 for the paper strip winder 9 is arranged on the machine table 24 (on the basic machine). The driving gear wheel 22 is mounted on the motor shaft. The motor suspension is movable (for example by a rocker) and is pretensioned by means of a tension spring (not shown).

When the integrated tool unit 10 is inserted into the clamping device 13 on the crimping station 6, the gear wheel 22 of the motor shaft and the gear wheel 21 of the spool 20 of the paper strip winder 9 then engage one another (FIG. 5). As a result of this spring pretension, the gear wheel drive is kept connected. In this way, the drive is easily coupled to the paper strip winder 9 in an operationally reliable manner.

The spring-actuated rocker switch 25 is mounted in the deflection region of the contact strip guide 8. As soon as the tension in the contact strip 12 increases, a switch plate on the rocker switch 25 actuates the sensor 26 (FIG. 2) which is fixed on the machine table 24. The drive motor 23 for the paper strip winder 9 is then put into operation by the sensor 26.

The paper strip (as release layer) is now unwound from the contact spool 44 (after the crimping of the contacts) and wound up by the paper strip winder 9. Here, the contact strip spool 44 is slowly rotated on the axle and the contact strip is transported so that the rocker switch 25 swings back according to the spring force and releases the sensor 26 again. The drive motor 23 is stopped again thereby.

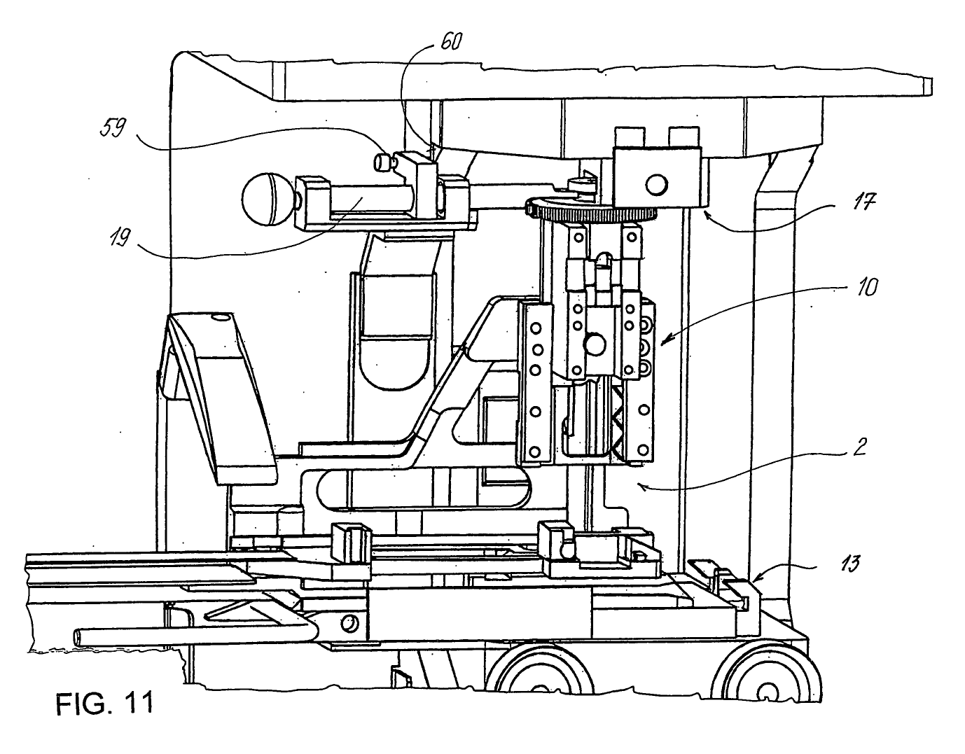

According to our experience, the conversion time of the above crimping machine 1 can be considerably reduced in particular by using the integrated tool unit 10 according to the invention, since—compared with the work phases discussed in the introduction to the description—only the following work is required:
open the pneumatic adjusting head fixing means 17 on the holding slide 16 of the crimping station 6 by pressing a push button,
release the clamping device 13 for the integrated tool unit 10 on the crimping station 6 by swiveling the lever 14,
withdraw the integrated tool unit 10 manually from the crimping station 6 (as a result, the slide 19 automatically locks the head 15 of the crimping tool by means of an integrated pressure spring) and remove,
hang the removed tool unit 10 in the storage rack 27,
remove new adjusted tool unit 10 from the storage rack 27,
insert the new adjusted tool unit 10 into the clamping device 13 and adjusting head fixing means 17 of the crimping station 6 (as a result, the slide 19 can be held back, for example by the stop 49 resting on the crimping device wall, so that the head 15 of the crimping tool 2 is free in the end position of the integrated tool unit 10 (TSS); cf. FIG. 11 below),
actuate the lever 14 of the clamping device 13 on the crimping station 6 for clamping,
actuate push button for closing the pneumatic adjusting head fixing means 17 on the holding slide 16 of the crimping station 6.

According to our experience with the prototype, it should be mentioned that a significant time saving for conversion of the crimping machine 1 can be expected with the use of the invention, with the result that the productivity of cable assembly can be increased. This is achieved by the arrangement according to the invention and in particular by the special integrated tool unit 10. In addition, this is also achieved by virtue of the fact that
the contact strip spool 44 need not be changed;
the contact strip 12 need not be removed from the crimping tool 2 and
the crimping tool 2 need not be set up for the new contact strip;
the rewinding of the loose contact strip end with paper strip onto a connector spool is unnecessary;
the paper strip need not be removed from the paper strip spool and threaded in again after insertion of the new contact spool.

The retrofitting of the tool unit 10 can be implemented according to needs in the storage position thereof so that the crimping machine is not obstructed thereby.

FIG. 1 shows that the crimping machine 1 according to the invention, in the particular embodiment shown, is equipped with an automatic tool identification system 49 (abbreviated to ATIS) which is a bidirectional high-frequency identification device by means of which the data of the crimping tool 2 can be selectively written to a storage area or read out from the storage area (other solutions for this purpose are also possible, e.g. transponder).

As is known, the crimping parameters or the program must be manually selected each time when a tool is changed on a known crimping machine. The concept of automatic adaptation of the crimping machine to the crimping tool currently being used would therefore be desirable. With the ATIS 49 according to the invention, these processes can be automated and at the same time quality control can be promoted.

In order to realize the automatic tool identification system 49, the crimping machine 1 must be able to communicate with a crimping tool 2 (FIG. 1). Here, the known “RFID” technology is used as a possible form of wireless electronic data acquisition (cf. for example U.S. Pat. No. 6,047,579).

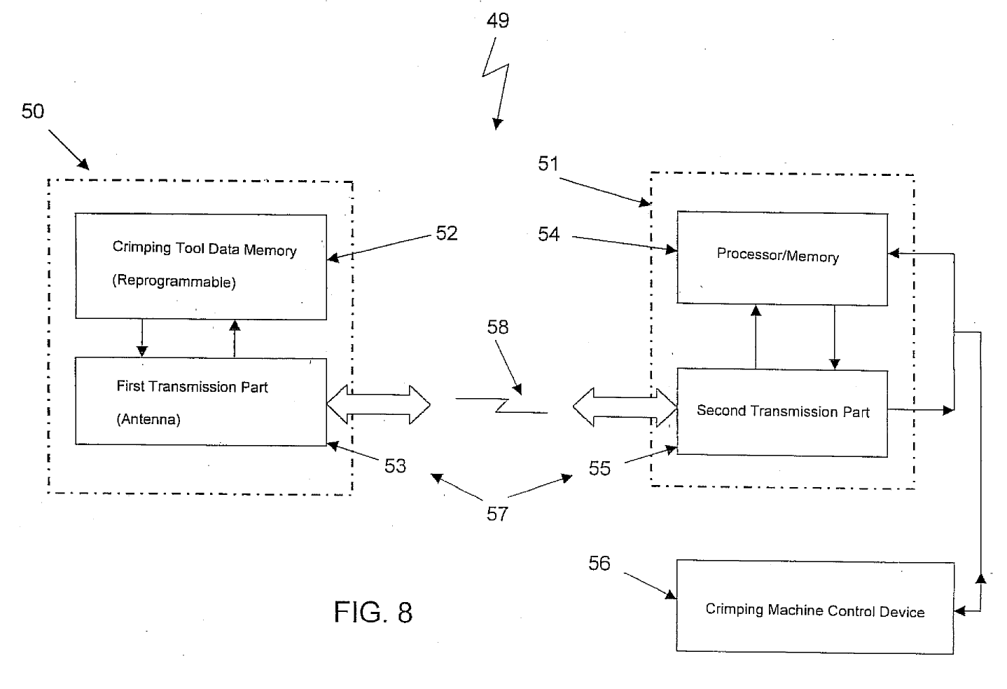

According to FIG. 8, the automatic tool identification system 49 according to the invention consists of two units separated from one another and having wireless communication with one another, i.e. of an identification unit (abbreviated to ID unit) 50 and a read unit 51. The ID unit 50 is coordinated with the crimping tool 2 (i.e. the portable integrated tool unit 10) but the read unit 51 is coordinated with the crimping machine 1.

In this embodiment, the ID unit 50 is in the form of a transponder which preferably consists of a reprogrammable tool data memory 52 (e.g. semiconductor chip) and of a first transmission part 53 (e.g. an aerial). The ID unit 50 (transponder) takes the energy directly from a magnetic field of the read unit 51 (receiver) so that it needs no separate battery or power source.

The tool data memory 52 of the ID unit 50 stores the information which is coordinated with the integrated portable tool unit 10 and comprises the preselected characteristic properties/data of the crimping tool 2. The tool data memory 51 is connected to the first transmission part 53 of the ID unit 50 (FIG. 8).

The read unit 51 on the crimping machine 1 consists of a processor/memory 54 (FIG. 8) and a second transmission part 55, which cooperate with one another. The processor/memory 54 of the read unit 51 serves for storing characteristic properties, at least of the crimping machine. The read unit 51 is connected to a control device 56 of the crimping machine 1.

The first transmission part 53 of the ID unit 52 and the second transmission part 55 of the read unit 51 form a data transmission device 57 and have a bidirectional wireless data transmission link with one another, which is designated by an arrow 58 in FIG. 8.

The above data transmission device 57 in the form of a transmitting/receiving device transmits the crimping tool data obtained from the tool data memory 52 and receives data for storage in the processor/memory 54 of the read unit 51 (e.g. read/write memory), which is connected by the control device 56 to a production monitoring system of the crimping machine 1.

Because each integrated tool unit 10 is provided with one ID unit 52 each (and the tool data memory 52), which carries tool-specific required data, and these required data are then compared directly with the respective measured data in the read unit 51, no experimental complicated determination of the required data is necessary after a crimping tool change.

In the case of the above automatic tool identification system 49, it is therefore expedient to use a transponder solution. These transponders each have an identifier which is unique worldwide. This identifier is read in by the basic machine. The machine PCs have stored the identifiers of accessed crimping tools 2, integrated tool units (TSS) 10, etc. On equipping one of these components, the control loads the associated data from the server or PC on the basis of the identifier.

Overall, the invention (use of ATIS in crimping machines) provides a possibility for monitoring, without time losses and in an extremely reliable manner, the quality of crimp connections produced with a very wide range of tools, it also being possible to forecast the state of the crimping tools 2 themselves. The tool-specific required data stored on the crimping tool itself relate not only to the crimping tool 2 itself but preferably also to the crimp connection component and the cable for which the crimping tool is to be used. They do not depend or depend only slightly on the respective crimping machine 1 and, if appropriate, may contain additional parameters.

It should be emphasized that this invention (use of ATIS 49 in crimping machines) can be used not only in crimping machines having integrated and common changeable parts according to claim 1 but also in other crimping machines where a plurality of tools with tool-specific data—which serve for quality monitoring or for control of an apparatus operating with the tool—are used alternately in one or more devices.

By means of the automatic tool identification system (ATIS) 49 according to FIG. 8, the crimping tools 2 or other tools or objects can be uniquely identified, monitored and managed, and the data can be linked directly locally to the objects. The parameters used, can be stored on the tool. The data are thus directly coupled to the object.

If the integrated tool unit 10 in the crimping machine 1 is changed, these parameters therefore remain stored. On renewed use on one of the crimping machines 1, the stored parameters are loaded again. The operator need only select the cross-section. The crimp height would be set via an automatic height adjustment.

The crimping tools 2 could be preprogrammed by the manufacturer so that the customer has less setting-up work to do.

The automatic tool identification system (ATIS) 49 can, if appropriate, be provided with a cycle counter (not shown). Thus, it is possible to determine exactly for how many cycles an integrated unit 10 has already been used. By means of a possible logging function, it is possible to determine which crimping tool 2 was used with which settings on which crimping machine 1, and how often. This is helpful for quality assurance and for tracing back production errors.

A blocking function is also possible in the case of the automatic tool identification system (ATIS) 49. After a certain cycle time, it is possible to be alerted to the fact that the crimping tool 2 has to be revised. The crimping tool 2 could even be blocked, i.e. a crimping machine 1 no longer cooperates with the crimping tool 2 until the block is cancelled again by authorized persons. It is an important function for the periodic maintenance of the crimping tool 2. An increased life time and finally better quality of the end product follow therefrom.

The functions of an automatic tool identification system (ATIS) 49 can, if appropriate, be used only with the company-specific crimping machines 1 and crimping tools 2.

According to our experiments with prototypes and theoretical considerations, the following are the most important advantages of the above ATIS technology:
a contactless identification,
reading and writing of the transponder 100 000 times,
identification of the tool within a few seconds or fractions of a second,
resistant to environmental influences (extreme temperatures, humidity, etc.),
shape and size of the transponder can be adapted as desired,
the transponder can be integrated completely into the crimping tool,
high level of security through copying protection and possible data protection through password and encrypted data transmission.

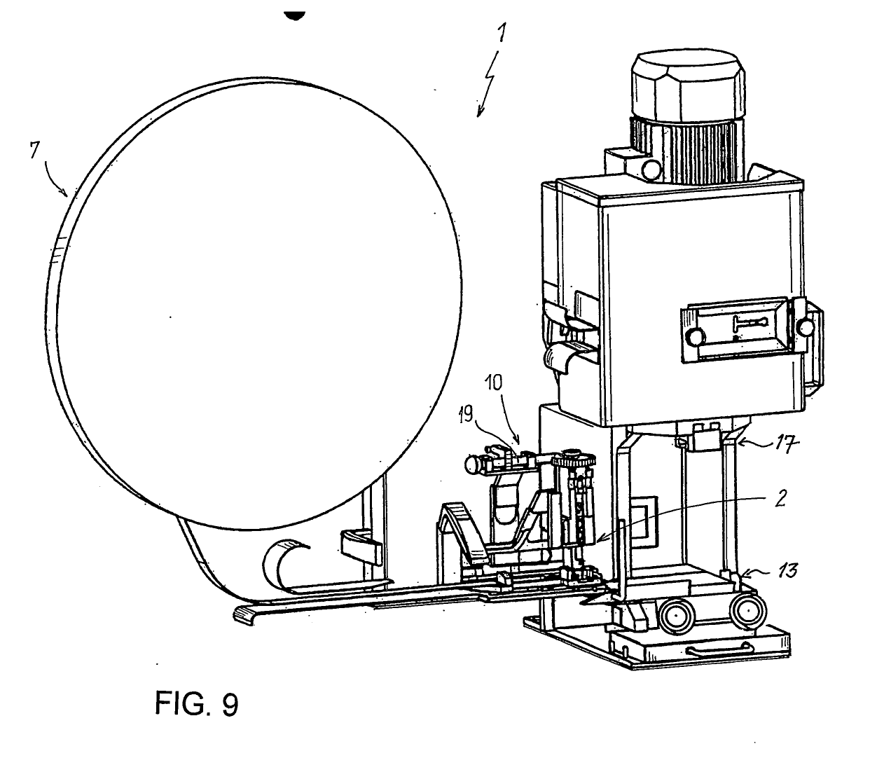

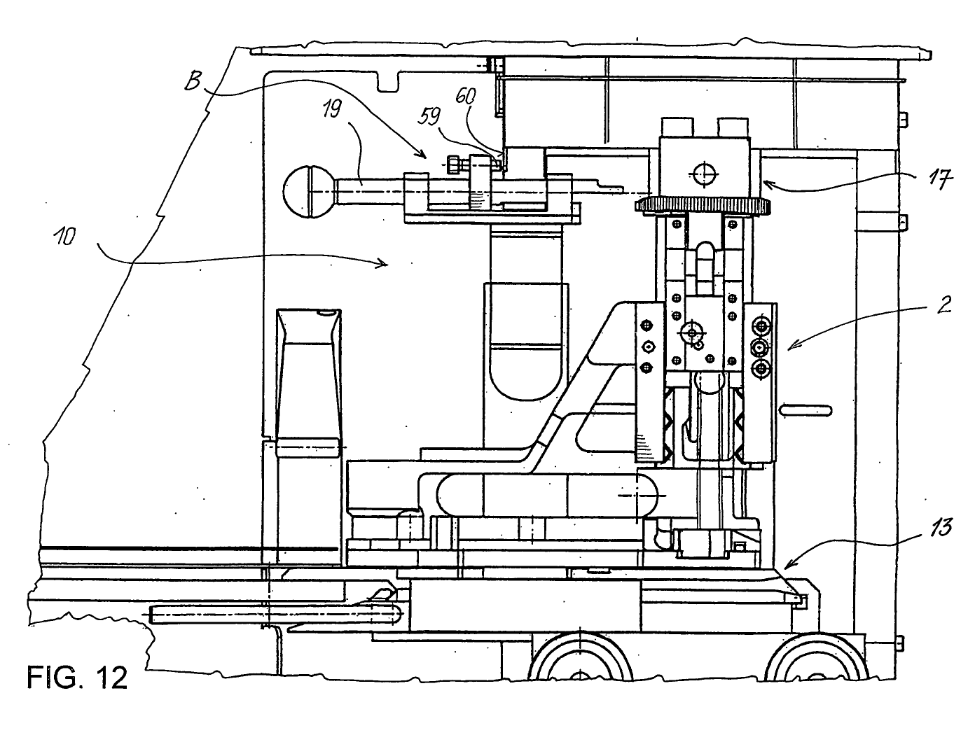

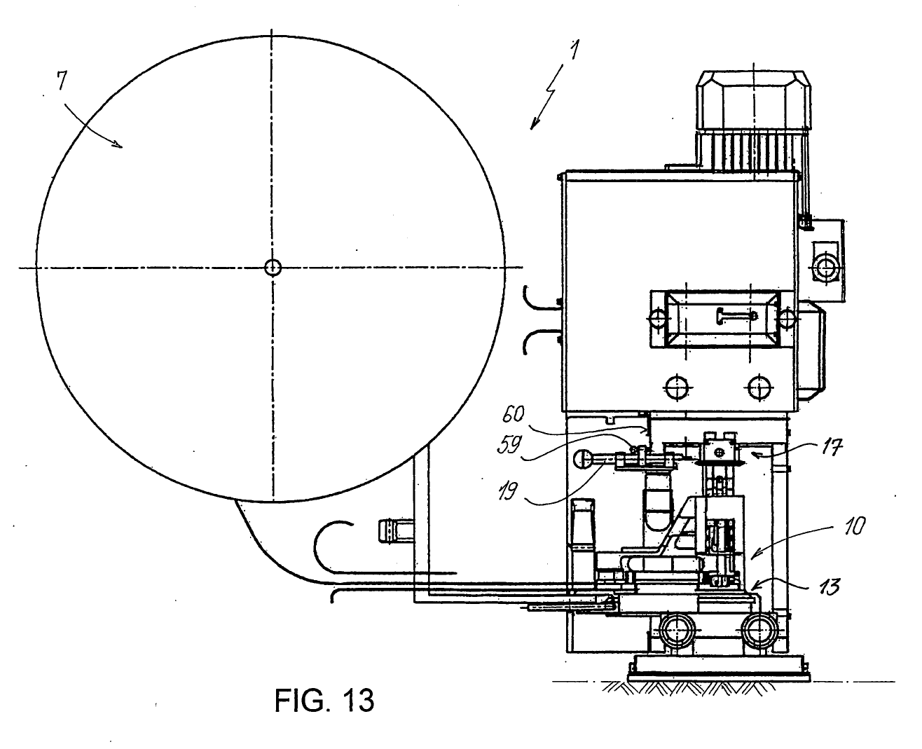

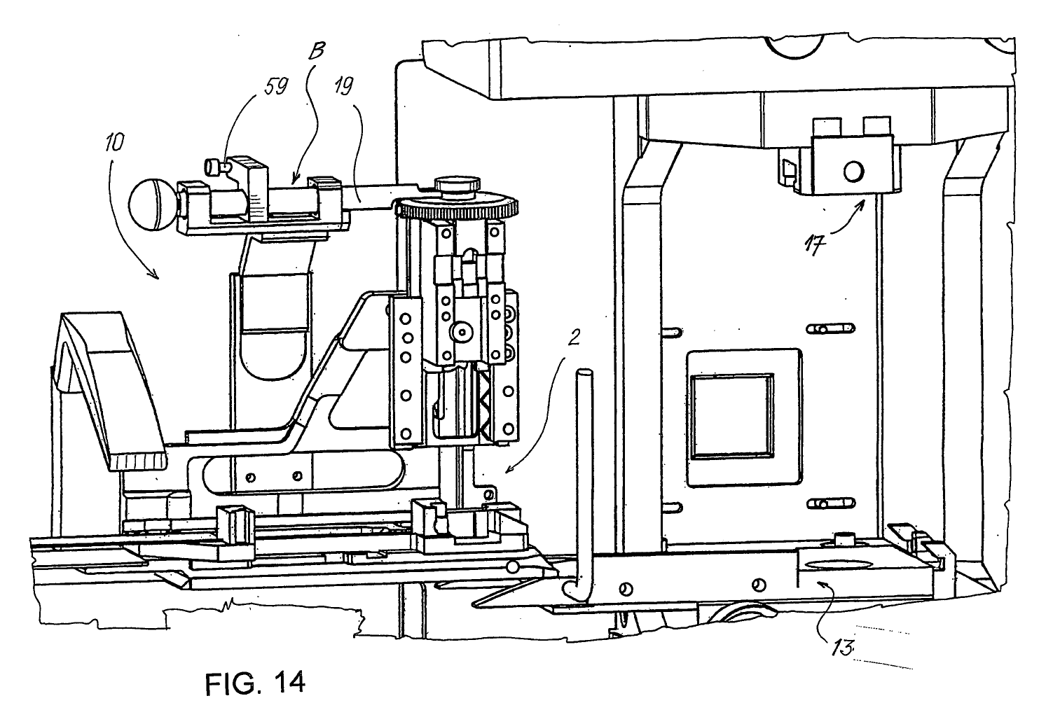

FIGS. 9-14 show a further working example of the crimping machine 1 according to the invention which is in the form of a “table-top device”. Below, we describe only the most important differences compared with the first embodiment (similar details were provided with the same reference numerals).

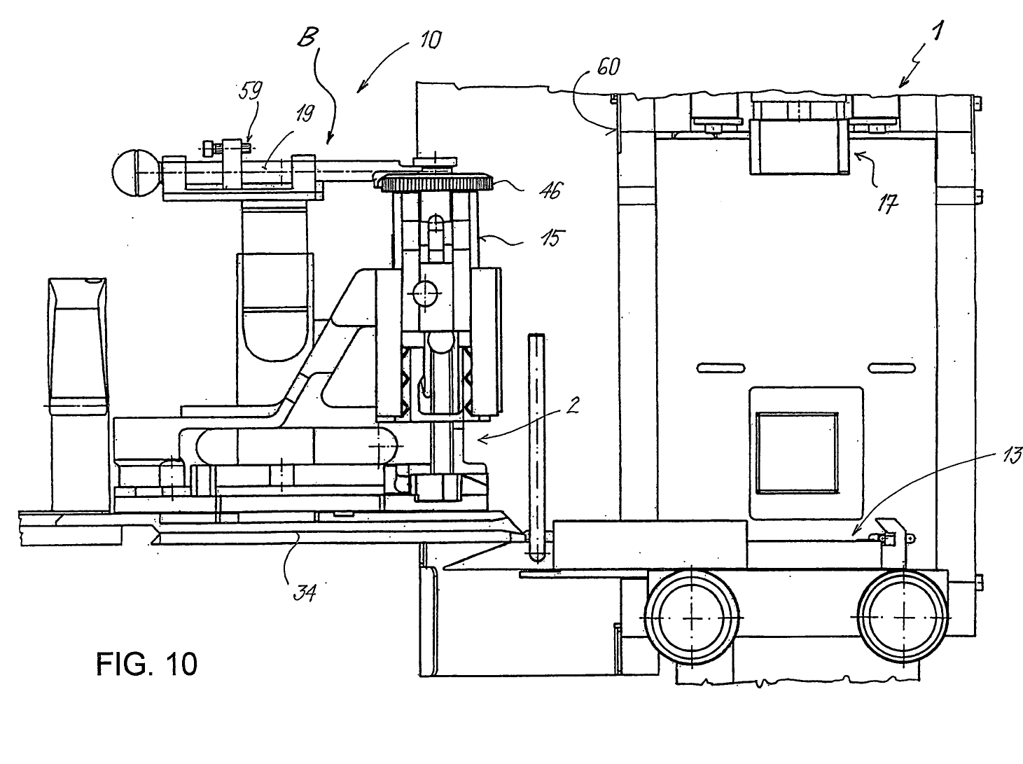

As illustrated in FIGS. 10-12, the slide 19 is further developed in this embodiment; it is provided with an axially adjustable stop 59 which, on insertion of the integrated tool unit (TSS) 10, rests on a side wall 60 of the crimping machine 1. When the integrated tool unit 10 is moved further to the end position, the slide 19 is held in its position by the stop 59 so that the crimping tool head 15 is released in the end position of the integrated tool unit 10. The integrated tool unit 10 is shown prior to insertion in FIG. 10 but in its inserted end position in FIGS. 11-14.

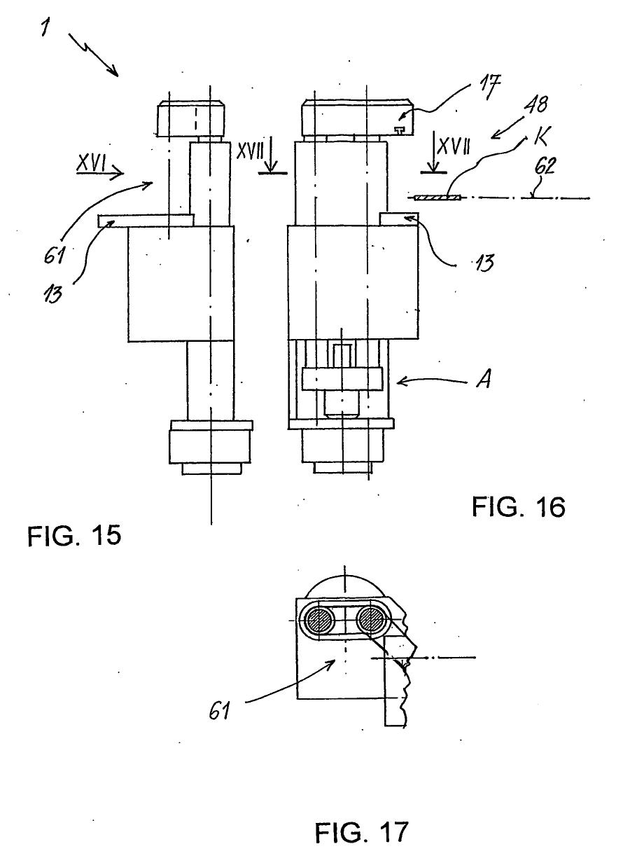

FIGS. 15-17 show a further arrangement of the crimping machine 1 according to the invention, FIG. 16 being a side view in the direction of an arrow XVI in FIG. 15, and FIG. 17 being a section along the line XVII-XVII in FIG. 15.

This crimping machine is therefore designed so that, in the region of the tool holder 48, there is the greatest possible available space for the integrated tool unit 10, which offers a C-shaped receptacle 61 open on three sides, and which permits satisfactory feeding of the integrated tool unit 10 (not shown here); in FIG. 16, the lower clamping device 13 and the upper adjusting head fixing means 17 for the integrated tool unit 10 are shown only schematically.

In this embodiment, however the drive unit A is arranged at the bottom. This permits, for example, a novel “underfloor press” which has the drive unit A (i.e. the known main drive: motor, gear, lever mechanism, etc.) below the tool operating plane 61 (optionally under the machine table 24). Here, a cable section K is shown in the tool operating plane 61.

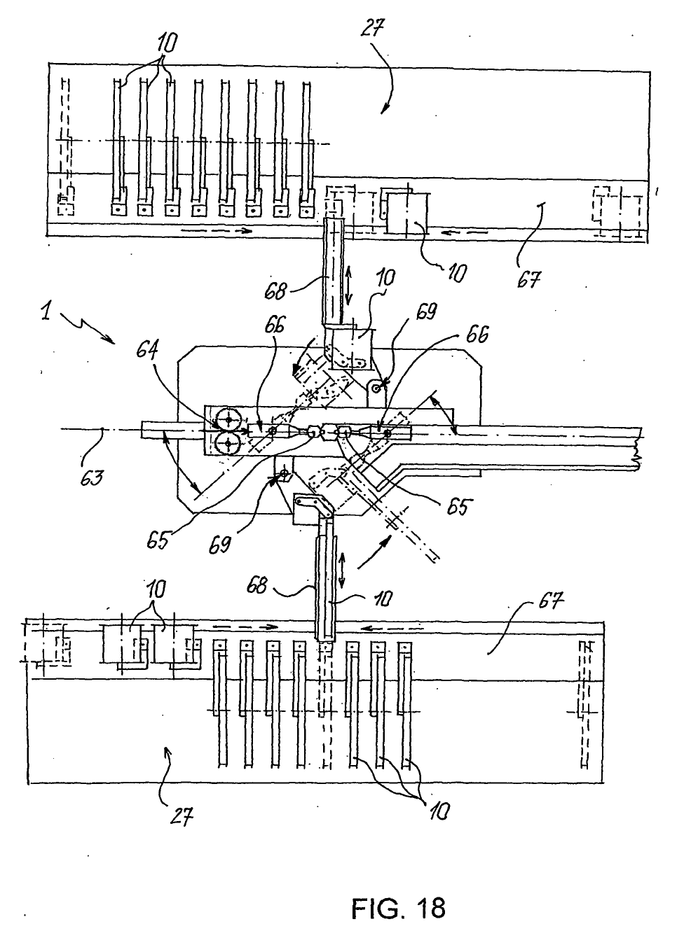

FIG. 18 shows a preferred arrangement of the crimping machine 1 according to the invention which is in the form of a modular cable processing centre by a twin arrangement of two crimping presses according to the invention.

In this twin arrangement, at least one cable feed unit 64, two pivotable cable handling modules 65, each having an assembly or swivel unit 66 and a crimping press according to the invention on each of two sides (i.e. one crimping station 6 each, comprising a drive unit A, a crimping tool 2 or an integrated tool unit) and one assembly or swivel mechanism 69 each are arranged along a cable path 63 (which simultaneously forms a centre line of the crimping machine 1).

In addition, a storage rack 27 is arranged on each of the two sides. Each storage rack 27 is preferably provided with one linear link 67 each for the controlled displacement of a tool unit or a group of different integrated tool units 10. It should be noted that two, but different, integrated tool units are designated by the same reference numeral “10” in FIG. 18 (the thicker tool unit is suitable for end feeding of the contacts and the other for lateral contact feeding).

One feed fin 68 each—preferably for the automatic feeding and removal of the integrated tool unit 10—is provided on each of the two sides, between the storage rack 27 and the crimping station 6.

The assembly mechanism, preferably swivel mechanism, 69 for swiveling an integrated tool unit 10 from a change position (designated by a continuous line) to an operating position (designated by a dash-dot line) is therefore provided between the storage rack 27 and the feed fin 68 and the crimping station 6. Here, the assembly or swivel mechanism 69 is connected to the drive unit A of the associated crimping press, and makes this too displaceable from the change position to the operating position.

It should also be noted that automatic cable processing machines can be designed according to the proven swivel arm principle (optionally also according to the linear transfer system) but have a novel press, i.e. the crimping machine 1 according to the invention.

The integrated tool units 10 are held completely and (preferably adjusted) in a holding device (i.e. in the storage rack 27) in which the plug strip (the contact strip 12) is also held and hence the plug strip remains permanently inserted in the crimping tool 2.

The storage rack 27 can be fed manually or automatically to the new crimping machine 1 and removed therefrom. Optionally, special feed tables manage the various storage racks and feed them automatically and in a programmed manner to the crimping presses and receive these devices again automatically after use.

The last two embodiments are—in our experience—associated with the following additional advantages:
the integrated tool units 10 can be very easily changed with inserted strip material (i.e. contact strip, e.g. in cassette form);
the tool units 10 which can be fed to the basic machine laterally or at the end can be used from the same side or direction;
automatic changing of the integrated tool units 10 is also possible;
this arrangement provides a very clear layout of the tool and of the basic machine during operation;
the setup times are surprisingly short;
the crimping safety is significantly increased;
high acceptance by the machine operators.

### LIST OF REFERENCE NUMERALS

1 The crimping machine
2 The crimping tool
3 The upper tool
4 The lower tool
5 The crimp contact
6 The crimping station
7 The contact strip unwinder
7A The contact spool holder
8 The contact strip guide
9 The paper strip winder
10 The integrated portable tool unit (TSS)
11 The basic rack
12 The contact strip
13 The clamping device
14 The lever
15 The crimping tool head
16 The holding slide
17 The adjusting head fixing means
18 The adjusting head
19 The slide
20 The spool
21 The driving gear wheel
22 The driven gear wheel
23 The drive motor
24 The machine table
25 The rocker switch
26 The sensor
27 The storage rack
28 The chassis
29 The wheel
30 The holding brake
31 The handle
32 The upper holding rail
33 The lower holding rail
34 The baseplate
35 The play
36 The T-slot
37 The adjusting head holder
38 The pneumatic cylinder
39 The guide bar
40 The stop
41 The centering element
42 The toggle lever clamping system
43 The contact spool receptacle
44 The contact strip spool
45 The covering
46 The adjusting wheel
47 The transverse contact feed
48 The tool holder
49 Automatic tool identification system (ATIS)
50 The identification unit (abbreviated to ID unit) on the crimping tool unit (10)
51 The read unit on the crimping machine
52 The tool data memory
53 First transmission part
54 The processor/memory
55 Second transmission part
56 The control device for the crimping machine
57 The data transmission device for bidirectional wireless data transmission
58 The arrow
59 The stop
60 The side wall of the crimping machine
61 The receptacle for the 10
62 The tool operating plane
63 The cable path/center line of the machine
64 The cable feed unit
65 The cable handling module
66 The assembly or swivel unit
67 The linear link
68 The feed fin
69 The assembly or swivel mechanism
A The drive unit of the tool
B The blocking mechanism
K The cable
T The carrying handle
X The arrow

1-24. (canceled)

25. A crimping machine for one of semiautomatically and fully automatically mounting a contact element to a cable end during cable assembly, the crimping machine comprising:
a crimping station (6) having a crimping tool (2),
a tool holder (48),
a drive unit,
a contact feed (47), and
a contact store,
the crimping tool (2) and the contact store being an assembly which is separable from the drive unit, the crimping tool (2) comprising a first part and a second part, and the tool holder (48) having a clamping device (13) for the first part (4) of the crimping tool (2) and a pneumatically actuatable adjusting head fixing means (17) for orienting and fixing the second part (3) of the crimping tool (2).

26. The crimping machine according to claim 25, wherein the contact feed (47) has a contact strip un-winder (7) and at least one contact strip guide (8), at least one of the contact strip guide (8) and a contact strip spool (44) are axially displacable for establishing alignment with the crimping tool (2).

27. The crimping machine according to claim 25, wherein the assembly is an integrated tool unit (10) which comprises at least the crimping tool (2), a contact strip un-winder (7) with a contact strip spool (44), a contact strip guide (8) and a drivable paper strip winder (9), the paper strip winder (9) has at least one of a static brake and an adjustable spring pretensioner.

28. The crimping machine according to claim 27, wherein the integrated tool unit (10) comprises a baseplate (34) which cooperates with the clamping device (13) when the integrated tool unit (10) is installed in the crimping station (6), and is an orientation means.

29. The crimping machine according to claim 25, wherein the clamping device (13) is provided with at least one of lateral guide bars (39), at least one centering element (41) and at least one stop (40) for orienting a baseplate (34) of the integrated tool unit (10) on the crimping station (6), and the baseplate (34) has elements cooperating in a diametrically opposite manner.

30. The crimping machine according to claim 25, wherein a rocker switch (25), coordinated with a contact strip guide (8), controls a driven paper strip winder (9) and is arranged on a basic rack (11) of a integrated tool unit (10).

31. The crimping machine according to claim 25, wherein the adjusting head fixing means (17) has a pneumatic cylinder (38) for fixing an adapted crimping tool head (15) on the crimping station (6).

32. The crimping machine according to claim 25, wherein a blocking mechanism (B) prevents advancement of the movable second part (3) of the two-part crimping tool (2) in an integrated tool unit (10) during changing of the integrated tool unit (10).

33. The crimping machine according to claim 32, wherein the blocking mechanism (B), in a blocking state, cooperates with an adjusting head (18) by at least one of an optionally hand-actuatable slide (19) and an interlocking lever, which, when the crimping tool (2) is inserted into one of the crimping machine (1) and an integrated tool unit (10), automatically eliminates the blocking state as soon as the movable second part (3) is held in the adjusting head fixing means (17).

34. The crimping machine according to claim 25, wherein an integrated tool unit (10) includes a portable basic rack (11) which has at least one handle (T).

35. The crimping machine according to claim 25, wherein a separate storage rack (27) is temporary storage of integrated tool units (10).

36. The crimping machine according to claim 35, wherein the storage rack (27) comprises a linear link (67) for controlled displacement of at least one of an a single integrated tool unit (10) and a group of different integrated tool units (10).

37. The crimping machine according to claim 35, wherein a feed fin (68) is arranged between the storage rack (27) and the crimping station (6) for automatic feeding and removal of the integrated tool unit (10).

38. The crimping machine according to claim 35, wherein a swivel mechanism (69) is arranged between the storage rack (27) and a feed fin (68) and the crimping station (6) for swiveling an integrated tool unit (10) from a change position to an operating position.

39. The crimping machine according to claim 38, wherein the swivel mechanism (69) is connected to the drive unit (A) of the crimping tool (2) and enables displacement the drive unit (A) of the crimping tool (2) from the change position to the operating position.

40. The crimping machine according to claim 25, wherein at least one cable feed unit (64) and two pivotable cable handling modules (65), one crimping press with a drive unit (A) on each of two sides of the crimping machine, and one of a further assembly and a swivel mechanism (69) are arranged along a cable path (63) which forms a center line of the crimping machine.

41. The crimping machine according to claim 40, wherein a feed fin (68) and a storage rack (27) are arranged on each of the two sides of the crimping machine.

42. The crimping machine according to claim 40, wherein the one of the assembly and the swivel unit (66) is coordinated with each cable handling model (65).

43. The crimping machine according to claim 25, wherein the drive unit (A) of the crimping tool (2) is arranged below a tool operating plane (62).

44. The crimping machine according to claim 25, further comprising a tool identification system which includes a data memory and a data transmission device for transmitting data from the data memory and for receiving data for the data memory, the tool identification system is an automatic tool identification system (49) with an identification unit (50) that communicates wirelessly with a read unit (51), the identification unit (50) is coordinated with an integrated tool unit (10) and the read unit (51) being coordinated with the crimping machine (1), the identification unit (50) consists of a re-programmable tool data memory (52) and a first transmission part (53), and the read unit (51) consists of a processor/memory (54) and a second transmission part (55), and the read unit (51) has a control link to the crimping machine (1).

45. The crimping machine according to claim 44, wherein the re-programmable tool data memory (52) is a semiconductor chip which is hermetically sealed with suitable packaging from a surrounding environment.

46. The crimping machine according to claim 44, wherein the first transmission part (53) of the identification unit (50) is an aerial.

47. The crimping machine according to claim 46, wherein the aerial transmits data and power.

48. The crimping machine according to claim 25, an automatic remote-controlled locking system fixes a structural unit on the crimping machine being provided for the structural unit.
